(19) United States
(12) Patent Application Publication
(10) Pub. No.: US 2009/0203492 A1
(43) Pub. Date: Aug. 13, 2009

(54) CARRIER OF A PLANETARY GEAR DEVICE, A PLANETARY GEAR DEVICE PROVIDED WITH THE CARRIER, AND AN OUTBOARD MOTOR PROVIDED WITH THE PLANETARY GEAR DEVICE

(75) Inventor: Yoshihiko Okabe, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi (JP)

(21) Appl. No.: 12/366,944

(22) Filed: Feb. 6, 2009

(30) Foreign Application Priority Data
Feb. 8, 2008 (JP) 2008-028855

(51) Int. Cl. F16H 57/08

(52) U.S. Cl. 475/331

(57) ABSTRACT

A carrier of a planetary gear device has a lid portion that has the shape of a disk that extends in a radial direction from a boss joined to a second rotational shaft, a bottom portion opposing the lid portion, and a sidewall portion that extends from a perimeter of the bottom portion toward the lid portion. A shielding wall that extends to a side of the bottom portion is arranged inside a perimeter of the lid portion. An end of the sidewall portion is connected to a corner portion arranged with the perimeter portion and the shielding wall. A connecting surface portion is welded in a direction from an outside. This arrangement provides a planetary gear type transmission device that reduces weight and cost while a necessary strength of a carrier is ensured, and an outboard motor provided with the transmission device.

### BACKGROUND TO THE INVENTION

1. Field of the Invention

The present invention relates to a carrier of a planetary gear device, a planetary gear device provided with the carrier, and an outboard motor provided with the planetary gear device.

2. Description of the Related Art

An outboard motor mounted on a stern receives large water resistance during travel. The outboard motor may include a planetary gear type transmission device, which can smoothly enable a shift change operation during acceleration and deceleration, mounted thereto. In general, the planetary gear type transmission device is provided with an internal gear connected to a side of an engine, a sun gear connected to a side of a housing, a carrier connected to a side of a propeller, and a plurality of planetary gears supported by the carrier through their shaft that mesh together with the sun gear and the internal gear (see WO 2007/007707A1 and JP-A-Hei 10-68450, for example).

In general, the carrier in WO 2007/007707A1 has a structure where a lid part is joined by welding it to a carrier main body in the shape of a cup that integrally defines a bottom part and a sidewall part. In this case, as shown in FIG. 9, a jaw part 100b has a stepped shape to prevent a spattering splash inside an upper edge of a sidewall part 100a of a carrier main body 100. Then, an end part 101a of the lid part 101 is connected to the jaw part 100b, and a connecting part 102 between the end part 101a and the jaw part 100b is welded from an upper direction (direction of the arrow in FIG. 9).

Further, as described in FIG. 1 of JP-A-Hei 10-68450, a carrier CR1 is formed with a carrier main body 27 and carrier covers 28, 29 joined by welding to a rib 30 in the shape of a pillar that extends from the carrier main body 27.

In a welding structure of the conventional carrier described in WO 2007/007707A1, it is necessary to secure thickness t1 necessary for welding and thickness t2 of the jaw part 100b necessary to prevent a spattering splash as board thickness t of the sidewall part 100a. Accordingly, the board thickness t of the sidewall part 100a becomes a thickness that exceeds a necessary strength. Therefore, the weight of the whole carrier main body including a bottom part is increased. It is also necessary to set a molding pressure at a time of pressing to a large value corresponding to the board thickness. This causes a problem of increased costs.

Similarly, in the carrier described in JP-A-Hei 10-68450, it is necessary to secure a thickness sufficient for welding and a thickness necessary to prevent a spattering splash as board thickness of the rib 30 (shown in FIG. 1 of JP-A-Hei 10-68450). Consequently, the thickness of the rib 30 becomes thick. This causes problems, for example, that the weight and size of the whole carrier is increased.

### SUMMARY OF THE INVENTION

In order to overcome the problems described above, preferred embodiments of the present invention provide a carrier of a planetary gear device that reduces the weight and cost while ensuring a necessary strength of the carrier, a planetary gear device provided with the carrier, and an outboard motor provided with the planetary gear device.

A preferred embodiment of the present invention is a carrier of a planetary gear device including a lid portion in the shape of a disk that extends in a radial direction from a central shaft, a bottom portion disposed to oppose the lid portion, and a sidewall portion that extends from a perimeter of the bottom portion toward the lid portion, wherein a shielding wall that extends to a side of the bottom portion is provided inside a perimeter portion of the lid portion, an end of the sidewall portion is connected to a corner portion arranged with the perimeter portion of the lid portion and the shielding wall, and a connecting surface portion is welded from an outside and then fixed.

Another preferred embodiment of the present invention is the carrier of a planetary gear device according to the above preferred embodiment, in which a joining portion that is thicker than other portions is arranged in a perimeter of the lid portion, and the shielding wall is arranged on an inside in a radial direction of the joining portion.

A further preferred embodiment of the present invention is the carrier of a planetary gear device according to one of the above-described preferred embodiments, in which the sidewall portion and the bottom portion are preferably thinner than the joining portion.

An additional preferred embodiment of the present invention is the carrier of a planetary gear device according to one of the above-described preferred embodiments, in which the sidewall portion and the bottom portion are integrally defined by a folded board-shaped member.

Yet another preferred embodiment of the present invention is the carrier of a planetary gear device according to one of the above-described preferred embodiments, in which the lid portion is made by casting, and the bottom portion and the sidewall portion are preferably made of integrally formed sheet metal.

Another preferred embodiment of the present invention provides a planetary gear device including an internal gear connected to an input shaft, a sun gear connected to a housing, the carrier according to one of the above-described preferred embodiments connected to an output shaft, and a planetary gear rotatably supported by the carrier and meshing together with the sun gear and the internal gear.

Another preferred embodiment of the present invention is the planetary gear device according to the above-described preferred embodiment, in which the planetary gear has a gear shaft passing through a lid portion and a bottom portion of the carrier and a gear main body rotatably supported by the gear shaft.

Another preferred embodiment of the present invention is provided with the planetary gear device according to one of the above-described preferred embodiments.

According to the carrier of a planetary gear device according to a preferred embodiment of the present invention described above, the shielding wall arranged to prevent a spattering splash is arranged on a side of the lid. Consequently, board thickness of the sidewall portion can be made to have a minimum thickness necessary for maintaining strength. As a result, the weight of the whole carrier can be reduced, and, at the same time, molding pressure can be reduced during pressing. Accordingly, a cost of the planetary gear device can be reduced.

In a preferred embodiment of the present invention described above, the joining portion that is thicker than other portions is arranged in the perimeter of the lid portion, and the shielding wall is arranged on an inside in a radial direction of the joining portion. Therefore, the weight and cost of the whole carrier can be further reduced.

In a preferred embodiment of the present invention described above, the sidewall portion and the bottom portion are arranged to be thinner than the joining portion. Consequently, the weight and cost of the whole carrier can be further reduced.

In a preferred embodiment of the present invention described above, the sidewall portion and the bottom portion preferably are integrally defined by folding a board-shaped member. Consequently, it is possible to make the bottom portion and the sidewall portion have the same board thickness. Accordingly, a weight of the whole sidewall portion and bottom portion can be reduced.

In a preferred embodiment of the present invention described above, the lid portion is preferably made by casting, and the bottom portion and the sidewall portion preferably are integrally defined by a unitary sheet metal member. Consequently, it is easy to form the thick joining portion and shielding wall on the lid portion. In addition, it is easy to provide the sidewall portion and the bottom portion with the same wall thickness.

In a preferred embodiment of the present invention described above, the carrier is adopted to provide a planetary gear device. Consequently, the weight of the whole planetary gear device can be reduced.

In a preferred embodiment of the present invention described above, the planetary gear is provided with the gear shaft passing through the lid portion and the bottom portion and the gear main body supported by the gear shaft with its shaft. Consequently, the weight and cost of the carrier can be reduced while support strength and rigidity of the planetary gear are ensured.

In a preferred embodiment of the present invention described above, the planetary gear type transmission device is disposed in the outboard motor. Consequently, the weight and cost of the whole outboard motor can be reduced.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view of a planetary gear type deceleration mechanism according to a preferred embodiment of the present invention.

FIG. 2 is a plan view of a carrier of a deceleration mechanism according to a first preferred embodiment of the present invention.

FIG. 3 is a side view (view III in FIG. 2) of the carrier.

FIG. 4 is a cross-sectional view (cross-sectional view taken along IV-IV in FIG. 2) of the carrier.

FIG. 5 is a side view of an outboard motor provided with a planetary gear type transmission device according to a second preferred embodiment of the present invention.

FIG. 6 is a rear view of a cross-section of the planetary gear type transmission device according to the second preferred embodiment of the present invention.

FIG. 7 is a cross-sectional view of a planetary gear type transmission mechanism of the transmission device according to the second preferred embodiment of the present invention.

FIG. 8 is a cross-sectional view of a planetary gear type deceleration mechanism according to the second preferred embodiment of the present invention.

FIG. 9 is a view showing a welding structure of a conventional, general carrier.

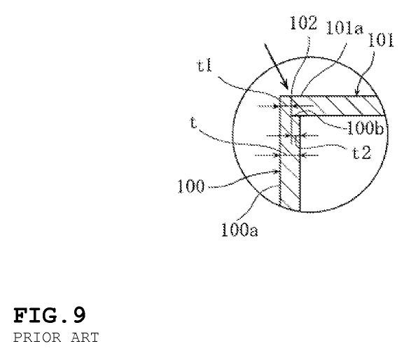

### DETAILED DESCRIPTION OF THE PREFERRED EMBODIMENTS

Preferred embodiments of the present invention will be described hereinafter with reference to accompanying drawings.

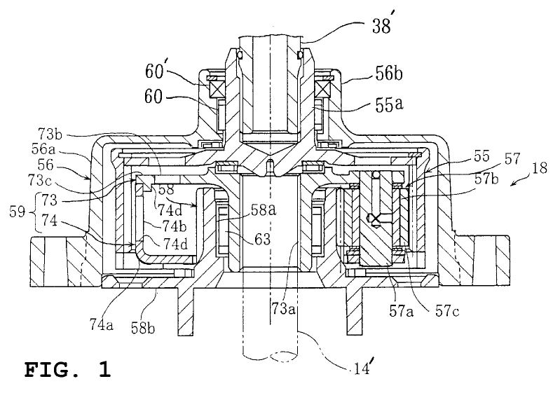

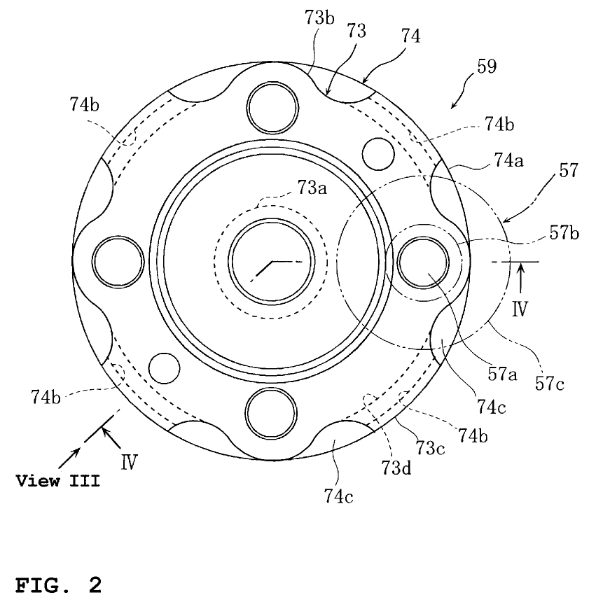

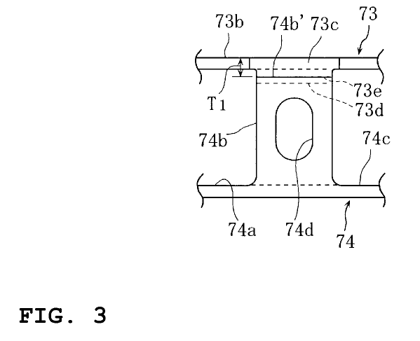

FIG. 1 to FIG. 4 are drawings for illustrating a carrier according to a first preferred embodiment of the present invention and a planetary gear device provided with the carrier.

In the drawings, reference numeral 18 denotes a planetary gear type deceleration mechanism as one preferred embodiment of the planetary gear device. The planetary gear type deceleration mechanism 18 is arranged, for example, to reduce rotational speed of an input shaft 38′ connected to a crankshaft (not shown) of an engine and, thus, to transmit the rotational speed to an output shaft 14′.

The planetary gear type deceleration mechanism 18 is provided with an internal gear 55, a sun gear 58, a carrier 59, and four planetary gears 57.

The internal gear 55 is housed in a deceleration housing 56 and is connected to and rotatable with the input shaft 38′. The sun gear 58 is non-rotatably connected to an output side housing (not shown) connected to the deceleration mechanism 18. The carrier 59 is connected to and rotatable with the output shaft 14′. The planetary gears 57 are rotatably supported by the carrier 59 and mesh together with the sun gear 58 and the internal gear 55.

The deceleration housing 56 has a housing main body 56a and a housing boss 56b. The housing main body 56a is generally in the shape of a cup that opens toward a lower direction and fixed on an upper surface on the output side housing by a bolt, for example. The housing boss 56b preferably has a cylindrical or substantially cylindrical shape and extends from the housing main body 56a to a side of the input shaft 38′.

The internal gear 55 has an internal tooth boss 55a preferably having a cylindrical or substantially cylindrical shape. The internal tooth boss 55a extends in the housing boss 56b, overlapping with the housing boss 56b in a view seen from a direction at right angles with the shaft. The internal tooth boss 55a is rotatably supported by the housing boss 56b via a bearing 60. Reference numeral 60′ denotes an oil seal.

The input shaft 38′ is coaxially joined in the internal tooth boss 55a by spline fitting. Therefore, the internal gear 55 rotates together with the input shaft 38′.

The sun gear 58 has a shaft 58a and a flange 58b. The shaft 58a preferably has a cylindrical or substantially cylindrical shape and has outer circumferential teeth with which each of the planetary gears 57 meshes. The flange 58b is in the shape of a disk that extends outward in the radial direction from a lower end of the shaft 58a. The flange 58b is fixed on an upper surface on the output side housing by a bolt, for example.

The carrier 59 has a carrier main body 74 and a lid portion member 73. The lid portion member 73 has a carrier boss 73a having a cylindrical or substantially cylindrical shape to which the output shaft 14′ is connected and an upper lid portion 73b in the shape of a disk that extends outward from an upper edge of the carrier boss 73a in the radial direction. The carrier main body 74 has a bottom portion 74a in the shape of a disk arranged to oppose the upper lid portion 73b and four sidewall portions 74b that extend from a peripheral edge of the bottom portion 74a toward the upper lid portion 73b.

The lid portion member 73 is preferably made by casting. The carrier main body 74 is preferably made of sheet metal that integrally defines the bottom portion 74a and each of the sidewall portions 74b. Specifically, the bottom portion 74a and each of the sidewall portions 74b preferably are integrally formed by folding a board-shaped member by pressing or forging, for example.

Each of the sidewall portions 74b of the carrier main body 74 is disposed at an interval of a predetermined angle in the circumferential direction. A portion of the planetary gears 57 projects outward from an opening 74c defined between the sidewall portions 74b. Further, a passing opening 74e passing through the sun gear 58 is defined in the bottom portion 74a of the carrier main body 74. A weight reduction hole 74d is arranged in each of the sidewall portions 74b to reduce weight.

The carrier boss 73a of the lid portion member 73 extends downward from the upper lid portion 73b toward the bottom portion 74a, overlapping with the sidewall portions 74b in a view seen from a direction at right angles with the shaft. The output shaft 14′ is preferably joined by spline fitting in the carrier boss 73a.

Each of the planetary gears 57 has a gear shaft 57a and a gear main body 57c. The gear shaft 57a is disposed to pass through the upper lid portion 73b and the bottom portion 74a and is fixed on the upper lid portion and the bottom portion preferably by caulking or the like, for example. The gear main body 57c is rotatably supported by the gear shaft 57a via a bearing 57b.

The carrier boss 73a of the carrier 59 is inserted and disposed in the shaft 58a of the sun gear 58 and relatively rotatably supported by the shaft 58a via a bearing 63.

A joining portion 73c that is thicker than other portions is arranged on a perimeter of the upper lid portion 73b of the lid portion member 73. The joining portion 73c has thickness T1 necessary for welding and is arranged in four places, for example, in the circumferential direction corresponding to each of the sidewall portions 74b.

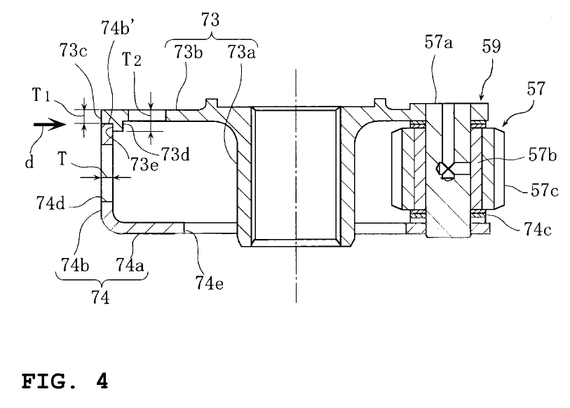

A shielding wall 73d is arranged inside in the radial direction of each joining portion 73c. The shielding wall 73d projects downward from the joining portion 73c toward the bottom portion 74a. Further, the shielding wall 73d has height size T2 (shown in FIG. 4) necessary to prevent a spattering splash and preferably has a size that is larger than thickness T1 of the joining portion 73c.

It is preferable that the thickness of the bottom portion 74a and each of the sidewall portions 74b of the carrier main body 74 is equal to a minimum size necessary to maintain strength and preferably has a thickness T that is thinner than thickness T1 of the joining portion 73c.

Further, an end portion 74b′ of each of the sidewall portions 74b of the carrier main body 74 is connected from a lower direction to a corner portion 73e provided with the joining portion 73c and the shielding wall 73d. A connecting surface portion between the sidewall portions 74b and the joining portion 73c is welded and joined from an outside in direction d.

According to a preferred embodiment, the carrier 59 of the planetary gear type deceleration mechanism 18 is provided with the lid portion member 73 and the carrier main body 74. In addition, the joining portion 73c that is thicker than other portions is arranged on a perimeter of the upper lid portion 73b of the lid portion member 73, and the shielding wall 73d that projects downward is arranged inside the joining portion 73c. Further, the end portion 74b′ of the sidewall portions 74b of the carrier main body 74 is connected to the corner portion 73e of the joining portion 73c and the shielding wall 73d. At the same time, the connecting portion is joined by welding, for example, from an outside. Therefore, a weight of the whole carrier 59 can be reduced while a necessary strength is ensured. At the same time, molding pressure can be reduced during pressing, and cost can be reduced.

In other words, both of the joining portion 73c having thickness T1 necessary for welding and the shielding wall 73d having thickness T2 necessary to prevent a spattering splash are disposed on a side of the lid portion member 73. Consequently, the sidewall portions 74b of the carrier main body 74 only need to have minimum thickness T that is necessary for maintaining strength. As a result, it is possible to make a thickness T of the sidewall portions 74b thinner than conventional thickness t obtained by adding thickness t1 necessary for welding and thickness t2 necessary to prevent a spattering splash.

In the present preferred embodiment, the bottom portion 74a and each of the sidewall portions 74b of the carrier main body 74 are arranged to be thinner than the joining portion 73c of the lid portion member 73. Consequently, a weight and cost of the whole carrier 59 can be further reduced.

In the present preferred embodiment, each of the sidewall portions 74b and the bottom portion 74a of the carrier main body 74 are preferably integrally formed by folding the board-shaped member. Consequently, thickness of the bottom portion 74a can be made to be the same thickness as thickness T of the sidewall portions 74b. Accordingly, a weight of the whole carrier main body 74 can be reduced.

In the present preferred embodiment, each of the planetary gears 57 is provided with the gear shaft 57a fixed on the upper lid portion 73b and the bottom portion 74a and the gear main body 57c supported by the gear shaft 57a by its shaft. Consequently, a weight and cost of the carrier 59 can be reduced while support strength and rigidity of the planetary gears 57 are secured.

In the present preferred embodiment, the lid portion 73 is preferably made by casting, for example. Consequently, it is easy to form the thick joining portion 73c and the thick shielding wall 73d on the lid portion member 73. In addition, the carrier main body 74 is made of the sheet metal integrally defining the bottom portion 74a and each of the sidewall portions 74b. Consequently, the carrier main body 74 can be easily formed from a board member of the same thickness.

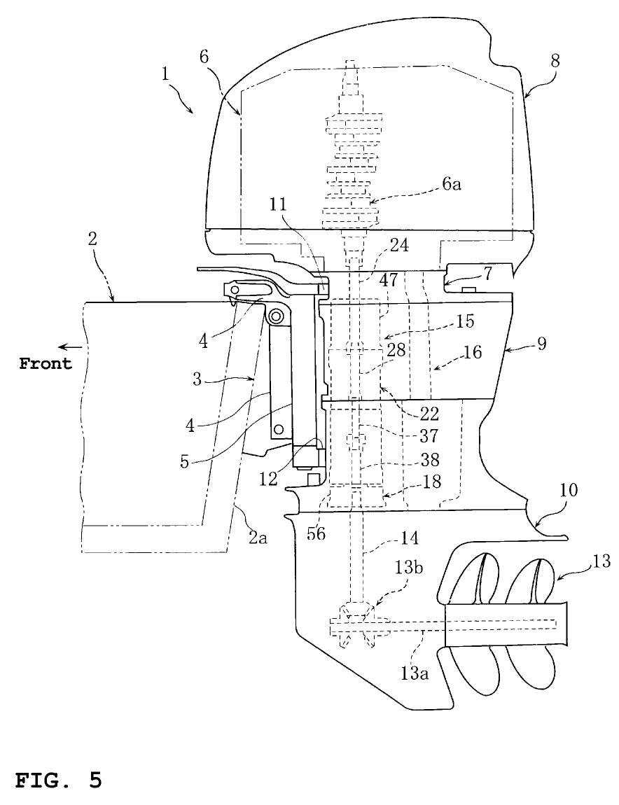

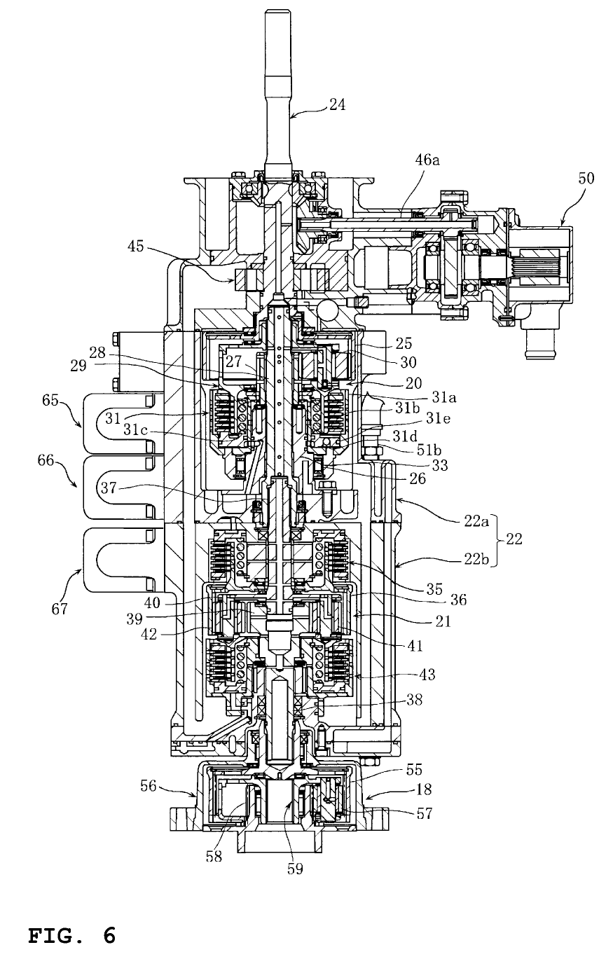

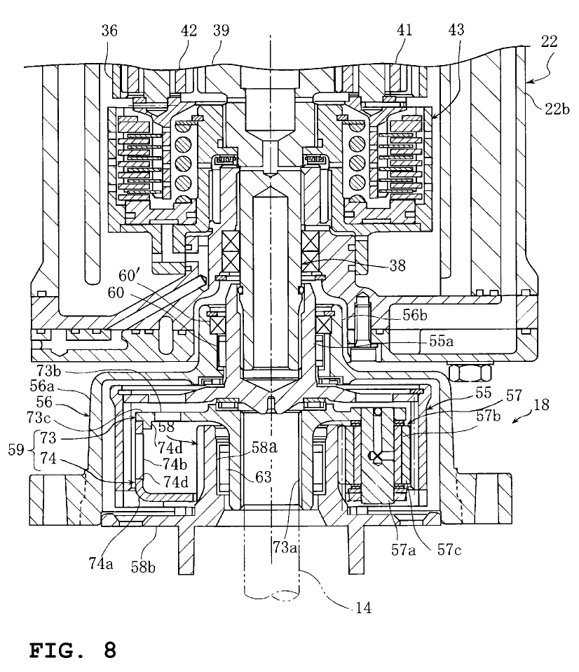

FIG. 5 to FIG. 8 are drawings for describing an outboard motor according to a second preferred embodiment of the present invention. In the drawings, the same reference numerals and symbols as those in FIG. 1 to FIG. 4 denote corresponding elements. The front, the rear, the left, and the right in the description of the present preferred embodiment denote the front, the rear, the left, and the right viewed from a rear direction of a boat unless otherwise noted.

In the drawings, reference numeral 1 denotes the outboard motor mounted on a stern 2a of a hull 2. The outboard motor 1 is vertically swingably supported by a clamp bracket 3 fixed on the hull 2 via a swivel arm 4 and is supported to be able to be steered to the left and to the right via a pivot 5.

The outboard motor 1 has an engine 6, an exhaust guide 7, a cowling 8, an upper case 9, a lower case 10, and a propeller 13.

The engine 6 is vertically disposed such that a crankshaft 6a is positioned generally perpendicularly therein. The engine 6 is attached to the exhaust guide 7. The cowling 8 is connected to an upper surface of the exhaust guide 7 and covers an outer circumference of the engine 6. The upper case 9 is connected to a lower surface of the exhaust guide 7. The lower case 10 is connected to a lower surface of the upper case 9.

The outboard motor 1 is supported by the clamp bracket 3 via an upper mount member 11 attached to the exhaust guide 7 and a lower mount member 12 attached to a lower end of the upper case 9.

Further, the outboard motor 1 is provided with a transmission device 15 that changes the rotational speed of the engine 6 and transmits the rotational speed to the propeller 13.

The transmission device 15 is provided with a first input shaft 24, a planetary gear type transmission mechanism 20, a planetary gear type forwarding-reversing switch mechanism 21, and the planetary gear type deceleration mechanism 18. The first input shaft 24 is connected to the crankshaft 6a that outputs motive power of the engine 6. The planetary gear type transmission mechanism 20 is connected to the first input shaft 24. The planetary gear type deceleration mechanism 18 is connected to the planetary gear type transmission mechanism 20.

The propeller 13 is mounted on a propeller shaft 13a disposed in the lower case 10 in a direction at right angles with the crankshaft 6a. The propeller shaft 13a is connected to a drive shaft 14 coaxially disposed with the crankshaft 6a via a bevel gear mechanism 13b.

The transmission device 15 is housed in a housing 22 preferably having a substantially cylindrical shape and arranged to be oil tight. The housing 22 is housed to be located in a foremost end in the upper case 9. An exhaust system 16 is disposed on a rear side of the transmission device 15 in the upper case 9 to emit exhaust gas from the lower case 10 into the water.

The housing 22 is divided into an upper housing 22a housing a shift change mechanism 20 and a lower housing 22b housing the forwarding-reversing switch mechanism 21.

The planetary gear type transmission mechanism 20 has a first internal gear 25, a first sun gear 27, a first output shaft 28, a first carrier 29, four first planetary gears 30, and a second clutch 31. The first internal gear 25 is connected to and rotatable with the first input shaft 24. The first sun gear 27 is connected to a side of the housing 22 via a first clutch 26. The first output shaft 28 is disposed to be coaxial with the first input shaft 24. The first carrier 29 is connected to and rotatable with the first output shaft 28. The first planetary gears 30 are relatively rotatably supported by the first carrier 29 and mesh together with the first sun gear 27 and the first internal gear 25. The second clutch 31 is interposed between the first sun gear 27 and the first carrier 29.

The first input shaft 24 is disposed coaxially with the crankshaft 6a and is joined to and rotatable with the crankshaft 6a.

The first sun gear 27 is housed and fixed in the housing 22 and is connected via the first clutch 26 to a support housing 33 that rotatably supports the first output shaft 28.

The first clutch 26 is preferably a one-way type clutch that enables rotation only in the rotational direction (clockwise rotation) of the crankshaft 6a of the first sun gear 27 and disables rotation in the opposite direction (counterclockwise rotation).

The second clutch 31 is preferably a multiple disc wet clutch and has a clutch housing 31a, a large number of clutch plates 31b disposed between the clutch housing 31a and the first carrier 29, a piston 31e, and a spring member 31c.

The clutch housing 31a is joined to and rotatable with the first sun gear 27. The piston 31e is disposed in a hydraulic pressure chamber 31d defined in the clutch housing 31a and pressurizes and connects the clutch plates 31b by hydraulic pressure supplied to the hydraulic pressure chamber 31d to transmit motive power. The spring member 31c urges the piston 31e in a direction that disconnects motive power.

When an operator operates a shift lever or a button (not shown) to a low speed gear side, the second clutch 31 enters a disconnected state. In this state, rotation of the engine 6 is transmitted from the first input shaft 24 to the first internal gear 25. When the first internal gear 25 rotates in the same direction, the first clutch 26 locks the first sun gear 27. Then, each of the planetary gears 30 rotates and revolves around the first sun gear 27 integrally with the first internal gear 25. Therefore, rotational speed of the engine is decelerated and transmitted to the first output shaft 28.

On the other hand, when an operation changes to a high speed side, the second clutch 31 enters a connected state. In this state, when the rotation of the engine 6 is transmitted from the first input shaft 24 to the first internal gear 25, the first clutch 26 releases the first sun gear 27. Then, the first internal gear 25, each of the first planetary gears 30, and the first sun gear 27 integrally rotate, and rotation of the first input shaft 24 is transmitted to the first output shaft 28 as it is.

The forwarding-reversing switch mechanism 21 preferably has a second internal gear 36, a second input shaft 37, a second output shaft 38, a second sun gear 39, a second carrier 40, a second planetary gear 41 and a third planetary gear 42, and a fourth clutch 43.

The second internal gear 36 is connected to the housing 22 via a third clutch 35. The second input shaft 37 is disposed coaxially with the first output shaft 28 and is connected to and rotatable with the first output shaft 28. The second output shaft 38 is disposed to be coaxial with the second input shaft 37. The second sun gear 39 preferably is integrally connected to the second output shaft 38. The second carrier 40 is connected to and rotatable with the second input shaft 37. The second planetary gear 41 is rotatably supported by the second carrier 40 and meshes together with the second sun gear 39. In addition, the third planetary gear 42 meshes together with the second internal gear 36. The fourth clutch 43 is interposed between the second carrier 40 and the second output shaft 38.

The fourth clutch 43 and the third clutch 35 are preferably multiple disc wet clutches having the same structure as the second clutch 31.

When a forwarding-reversing switch lever or a button (not shown) is in a neutral position, the third and the fourth clutches 35, 43 enter a disconnected state. Then, the second input shaft 37 idles, and rotation of the second input shaft 37 is not transmitted to the second output shaft 38.

When the neutral position is switched to a forwarding position, the third clutch 35 is in a disconnected state, and the fourth clutch 43 enters a connected state. Then, the second internal gear 36, the second and the third planetary gears 41, 42, and the second sun gear 39 integrally rotate. Further, the second output shaft 38 rotates in the same rotational direction, the forwarding direction, as the engine 6.

On the other hand, when the neutral position is switched to a reversing position, the third clutch 35 is in a connected state, and the fourth clutch 43 enters a disconnected state. Then, the second internal gear 36 is non-rotatably fixed in the housing 22, and the second and the third planetary gears 41, 42 rotate in directions opposite to each other and revolve at the same time. Further, the second internal gear 36 rotates in the opposite direction. Therefore, the second output shaft 38 rotates in the rotational direction opposite to that of the crankshaft 6a, that is, the reversing direction.

An oil pump 45 is coaxially disposed on the first input shaft 24. In addition, a water pump 50 is connected to the first input shaft 24 via a drive force output shaft 46a that is connected to the crankshaft 6a and defines right angles with the crankshaft 6a.

Oil pressure control valves 65 to 67 arranged to control oil pressure that is supplied to each of the clutches 31, 35, and 43 are disposed in a direction parallel or substantially parallel with the crankshaft 6a on the portside in the width direction of the boat of the housing 22. Each of the oil pressure control valves 65 to 67 is controlled by a controller (not shown) to open or close on the basis of a shift switch signal, a forwarding-reversing switch signal, and so forth.

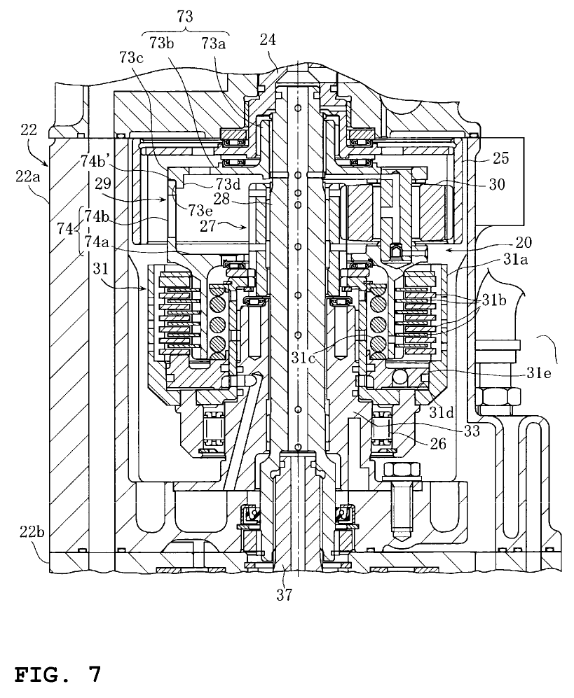

Here, as shown in FIG. 7, the same welding structure as the carrier 59 in the first preferred embodiment is preferably adopted for the first carrier 29 of the planetary gear type transmission mechanism 20 mentioned above, and a structure described below is provided. In the drawing, the portions denoted by the same reference numerals and symbols as those in FIG. 4 are the same as or similar to corresponding portions.

The first carrier 29 is provided with the lid portion member 73 and the carrier main body 74. The lid portion member 73 has the carrier boss 73a having a cylindrical or substantially cylindrical shape, and the upper lid portion 73b that extends in the radial direction from a lower edge of the carrier boss 73a. The carrier boss 73a projects upward from the upper lid portion 73b. The carrier main body 74 has the bottom portion 74a disposed to oppose the upper lid portion 73b and a plurality of sidewall portions 74b that extend upward from a perimeter of the bottom portion 74a.

The joining portion 73c that is thicker than other portions is arranged on a perimeter of the upper lid portion 73b of the lid portion member 73, and the shielding wall 73d projecting downward is arranged inside the boss 73c.

Further, the end portion 74b′ of each of the sidewall portions 74b is connected to the corner portion 73e provided with the boss 73c and the shielding wall 73d, and the connecting surface portion is preferably joined by welding from the outside.

In the second preferred embodiment, the first carrier 29 of the planetary gear type transmission mechanism 20 preferably has the same structure as the carrier 59 in the first preferred embodiment. Consequently, the weight of the first carrier 29 can be reduced, and, in addition, cost can be reduced.

In the second preferred embodiment, the carrier welding structure mentioned above is preferably adopted for the planetary gear type deceleration mechanism 18 and the transmission mechanism 20 of the outboard motor 1. Consequently, the weight and cost of the whole outboard motor 1 can be reduced.

In this preferred embodiment, the carrier welding structure mentioned above is preferably adopted for the planetary gear type transmission mechanism 20 that switches the rotational speed of the engine to a low-speed side or to a high-speed side. Consequently, the weight and cost of the transmission mechanism 20 can be reduced.

Further, in this preferred embodiment, the carrier welding structure mentioned above is adopted for the planetary gear type deceleration mechanism 18 that decelerates rotational speed of the engine. Consequently, a weight and cost of the deceleration mechanism 18 can be reduced. As a result, the weight of the whole outboard motor 1 can be reduced.

The present preferred embodiment has been described with the example of a planetary gear type transmission device disposed in the outboard motor. However, the range of the planetary gear device of the present invention is not limited to this example. For instance, the present invention can be applied to a planetary gear type transmission device disposed in an inboard engine or in a land vehicle.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A carrier of a planetary gear device, the carrier comprising:
a lid portion having a substantially disk-shaped configuration and extending in a radial direction from a central shaft;
a bottom portion opposing the lid portion; and
a sidewall portion extending from a perimeter of the bottom portion toward the lid portion; wherein
a shielding wall that extends to a side of the bottom portion is arranged inside a perimeter portion of the lid portion;
an end of the sidewall portion is connected to a corner portion arranged with the perimeter portion of the lid portion and the shielding wall; and
a connecting surface portion is welded and fixed to the carrier.

2. The carrier of a planetary gear device according to claim 1, wherein a joining portion that is thicker than other portions is arranged in a perimeter of the lid portion, and the shielding wall is arranged on an inside in a radial direction of the joining portion.

3. The carrier of a planetary gear device according to claim 2, wherein the sidewall portion and the bottom portion are thinner than the joining portion.

4. The carrier of a planetary gear device according to claim 1, wherein the sidewall portion and the bottom portion are integrally defined by a folded board-shaped member.

5. The carrier of a planetary gear device according to claim 1, wherein the lid portion is a cast material, and the bottom portion and the sidewall portion are integrally defined by a unitary sheet metal member.

6. A planetary gear device comprising:
an internal gear connected to an input shaft;
a sun gear connected to a housing;
the carrier according to claim 1 connected to an output shaft; and
a planetary gear rotatably supported by the carrier and meshing together with the sun gear and the internal gear.

7. The planetary gear device according to claim 6, wherein the planetary gear has a gear shaft passing through a lid portion and a bottom portion of the carrier, and a gear main body rotatably supported by the gear shaft.

8. An outboard motor provided with the planetary gear device according to claim 6.
